(19) United States
(12) Patent Application Publication
(10) Pub. No.: US 2007/0039920 A1
(43) Pub. Date: Feb. 22, 2007

(54) Method of fabricating nanochannels and nanochannels thus fabricated

(75) Inventors: Vladimir Gueorguiev Kutchoukov, Almere (NL); Adrianus Bossche, Capelle Aan Den Ijssel (NL); Frederic Laugere, Utrecht (NL); Wim Van Der Vlist, Delft (NL)

Correspondence Address: PEACOCK MYERS, P.C., 201 THIRD STREET, N.W., SUITE 1340, ALBUQUERQUE, NM, 87102, US

(73) Assignee: Technische Universiteit Deflt, Delft (NL)

(21) Appl. No.: 11/331,728

(22) Filed: Jan. 12, 2006

Related U.S. Application Data
(63) Continuation of application No. PCT/NL04/00549, filed on Aug. 4, 2004.

(30) Foreign Application Priority Data
Aug. 4, 2003 (NL) 1024033

(51) Int. Cl. C23F 1/00; H01B 13/00

(52) U.S. Cl. 216/2; 216/17

(57) ABSTRACT

A method of fabricating at least one nanochannel in a semiconductor material applied on a substrate, comprising the semiconductor material being subjected to an etching treatment and the substrate to a bonding treatment so as to attach a covering layer to the substrate, in which bonding treatment the semiconductor material is applied as bonding agent, and wherein prior to etching, the semiconductor material is locally doped for the formation of electrodes.

The present invention relates to a method of fabricating at least one nanochannel in a semiconductor material applied on a substrate, wherein the semiconductor material is subjected to an etching treatment and said substrate to a bonding treatment to attach a covering layer to the substrate. The present invention also relates to nanochannels fabricated by this method.

MCNAMARA S ET AL: ‘A fabrication process with high thermal isolation and vacuum sealed lead transfer for gas reactors and sampling Microsystems’, PROCEEDINGS OF THE IEEE 16TH. ANNUAL INTERNATIONAL CONFERENCE ON MICROELECTRO MECHANICAL SYSTEMS. MEMS 2003. KYOTO, JAPAN, AN. 19-23, 2003, IEEE INTERNATIONAL MICRO ELECTRO MECHANICAL SYSTEMS CONCFERENCE, NEW YORK, N.Y.: IEEE, US, vol. CONF. 16, 19 January 2003 (2003-01-19), pages 646-649, XP010637055 ISBN: 0-7803-7744-3 teaches a six mask fabrication process for vacuum-sealed microsystems including pressure and float sensors, reaction chambers and reservoirs, and channels ranging from 100 nm to 10 μm in hydraulic diameter. According to this publication a glass wafer is recessed to form the channels and metalised for providing a lower metal interconnect layer. A dielectric stack is deposited on a silicon wafer followed by the deposition and patterning of two polysilicon layers. The two layers are anodically bonded and the silicon is dissolved following which a contact cut is made in the dielectric stack completing the process with deposition and patterning of an upper metal layer.

In recent years, the fabrication of nanochannels has enjoyed much attention because of the increased interest in the manipulation and detection of separate molecules. The developments in the field of optical engineering are forever improving the possibilities of studying biochemical processes taking place on a molecular level. This opens up a vast research potential in, for example, the medical and biomedical field. Micro- and nanochannels, may, for example, be used for the separation of biomolecules, enzymatic assays and immunohybridisation reactions. An example of the utilisation of micro- and nanochannels is the optical detection of molecules. In such a case, it is important that at least one side of the channel be transparent to light. For this reason, a great deal of research is performed on the fabrication of nanochannels in transparent material. Electrical manipulation of molecules in the nanochannels may also be of interest for research. For this purpose, electrodes are applied at both ends of the channels. A good deal of research is therefor also performed on the development of nanochannels that are provided with electrodes.

In the prior art, it is common practice to etch channels into a glass plate or into an insulating intermediate layer of two glass plates and to subsequently bond the two glass plates by means of an adhesive. A drawback of this known method is that in this way the precision of the dimensions of the nanochannels is determined by the limited preci sion with which the adhesive layer can be applied between the glass plates. This limited precision may be a cause for leaks.

It is also known from the prior art, that after etching the channels, electrodes can be applied by vapour deposition, whereafter the two glass plates are bonded by way of an adhesive. A drawback of this known technique is that the alignment of the electrodes and the channels must be very accurate, which poses a considerable constructural difficulty limiting the employability of the nanochannels obtained in the known manner. In addition, the application of electrodes by this method may cause local variations in thickness of the intermediate layer, which after bonding of the glass plates may cause leakages.

From U.S. Pat. No. 6,517,736 a microfluid device is known comprising a silicon-wafer and a glass plate, wherein the silicon-wafer is provided with channels, while the wafer also serves as adhesive agent to the glass plate.

It is an object of the present invention to provide a method for the fabrication of nanochannels between a substrate and a covering layer, wherein the nanochannels formed are dimensioned very precisely and exhibit no leakages. It is preferred to use conventional techniques for the fabrication.

A further object of the present invention is to provide a method for the accurate placing of electrodes around the above-mentioned nanochannels, which method is easy to carry out, and which in addition does not hinder precise dimensioning of the nanochannels and does not cause leakages.

Prior to etching the channel into the layer of semiconductor material, the layer of semiconductor material is in a first aspect of the invention locally doped for the formation of electrodes. With the aid of ion-implantation techniques, predetermined sites in the semiconductor material are in this way provided with conductive portions. Subsequently, the channel is etched straight across said conductive portions, creating two electrodes at both sides of the channel. The result of this method is that the two electrodes are perfectly aligned in relation to each other and in relation to the channel. Due to the electrodes being applied by doping, the surface of the layer of semiconductor material stays very smooth so as to minimise the occurrence of leakages caused by the fact that the top and bottom layers do not join up.

The semiconductor material is applied to the substrate by means of, for example, LPCVD (Low Pressure Chemical Vapour Deposition). As substrate and covering layer it is possible to use, among other things, glass or a semiconductor wafer. However, glass is preferred because glass is transparent to visible light and this allows the products with the nanochannels to be employed for applications in which optical detection methods are used. As semiconductor material any appropriate kind of semiconductor may be used. However, amorphous silicon is preferred because of this material's low deposition rate, which allows the semiconductor material to be applied very accurately in the desired thickness. The thickness of the layer of semiconductor material lies in the order of several tens of nanometers but depending on the application, the layers may of course also be thicker or thinner, provided that the created layer allows nanochannels to be made and that a successful bond can be created between the substrate and the covering layer.

The nanochannel is etched into the semiconductor material and possibly also partly in the underlying substrate. This may be achieved by the usual etching techniques. The dimensions of the channel depend, among other things, on the technique used. With the usual lithographic techniques a channel width from approximately 0.5 μm can be achieved. If narrower channels are desired, it is possible to use, for example, beam lithography with which even channel widths of a few tens of nanometers can be achieved. The depth of the channel is determined by the length of time during which etching takes place and can therefor be adjusted as desired.

Finally, the covering layer is bonded with the substrate via the layer of semiconductor material provided thereon. This occurs preferably by anodic bonding. Anodic bonding occurs by heating the assembly to a temperature of at least 350° C. and preferably approximately 400° C., and by subsequently applying a high voltage of preferably approximately 1000 V to 1500 V to the assembly.

The invention is also embodied in nanochannels obtained by the above-elucidated method. These nanochannels are bounded by a substrate and a covering layer that is attached to the substrate, and are characterised by a layer of semiconductor material bonding the substrate with the covering layer, and in which semiconductor material dopant is applied locally to form electrodes.

Hereinbelow, a few exemplary embodiments are given to elucidate the present invention.

### EXAMPLE 1

In this example, a preferred method for forming a nanochannel between two glass plates is given.

As substrate and covering layer glass plates of the Borofloat-type were used, available from Bullen Ultrasonics Inc., U.S.A. These plates were provided with pre-drilled holes as in- and outlet for the nanochannels. With the aid of LPCVD (Low Pressure Chemical Vapour Deposition) an intermediate layer of amorphous silicon was applied on the substrate, having a thickness of 33 nm. With the aid of a photoresist mask the pattern of the nanochannel was applied on the intermediate layer, whereafter in an Alcatel fluoride etcher, the channels were etched into the intermediate layer and partly into the substrate.

Hereafter both the treated substrate with intermediate layer and the covering layer were cleaned in a solution of nitric acid. Subsequently the covering layer was applied on the substrate provided with the intermediate layer and the assembly was bonded in an Electronic Visions EVG501 bonder. To this end the assembly was preheated for two hours to 400° C., after which bonding took place at the same temperature, and by applying 1000 V for one hour. In this way a nanochannel was created having a depth of 50 nm, a width of 40 μm and a length of 3 mm.

### EXAMPLE 2

In accordance with the method of Example 1, nanochannels of various sizes were fabricated. In one series of experiments, the channels had a depth of 50 nm and a length of 3 mm and various widths. The narrowest channel had a width of 2 μm, the widest channel had a width of 100 μm. In another series of experiments, ladder-shaped channels were formed, wherein the one leg had a width of 2 μm and the other leg a width of 5 μm. Here also the depth of the channels was 50 nm.

The quality of the formed channels was checked with the aid of electron microscopy and fluorescence microscopy. For the fluorescence microscopic check a fluorescent liquid (Rhodamine 6G) was fed through the formed nanochannel. In all cases the fluorescent liquid flowed through the nanochannels as a result of capillary forces, without the application of over- or underpressure. The electron microscopic image from the electron microscopic check showed no irregularities in the channel. Moreover, no leakages were observed in any of the nanochannels fabricated in accordance with the present method.

This example shows that by the method in accordance with the present invention, nanochannels of various predetermined dimensions can be fabricated, without any obstructions, and through which therefore flow can take place. The nanochannels fabricated by the method according to the present invention appeared to be leakage-free.

What is claimed is:

1. A method of fabricating at least one nanochannel in a semiconductor material, the method comprising the steps of:
applying the semiconductor material on a substrate;
doping and etching the semiconductor material; and
bonding a covering layer to the substrate, wherein the semiconductor material is applied as bonding agent; and
wherein doping of the semiconductor material is done locally to form conductive portions in said semiconductor material; and
wherein etching of the locally doped semiconductor material is performed straight across said conductive portions so as to form the nanochannel in said semiconductor material, said conductive portions forming electrodes in the semiconductor material on both sides of the nanochannel.

2. A method according to claim 1, wherein etching of the locally doped semiconductor material is performed prior to the bonding of the covering layer to the substrate.

3. A method according to claim 1, wherein the substrate is bonded with the covering layer by applying a high potential difference across the substrate and covering layer at a temperature of at least 350° C.

4. A method according to claim 3, wherein the potential difference is approximately 1000-1500 V.

5. Nanochannels bounded by a substrate and a covering layer that is attached to the substrate, wherein a layer of semiconductor material bonds the substrate with the covering layer, wherein the nanochannels are embedded in said semiconductor material, and wherein dopant is applied locally to form electrodes on opposing sides of the nanochannel.
